(19) United States
(12) Patent Application Publication
(10) Pub. No.: US 2005/0091186 A1
(43) Pub. Date: Apr. 28, 2005

(54) Integrated method and apparatus for capture, storage, and retrieval of information

(76) Inventor: Alon Elish, Ein Sarid (IL)

Correspondence Address: GLENN PATENT GROUP, 3475 EDISON WAY, SUITE L, MENLO PARK, CA, 94025, US

(21) Appl. No.: 10/693,297

(22) Filed: Oct. 24, 2003

(51) Int. Cl. G06F 7/00

(52) U.S. Cl. 707/1

(57) ABSTRACT

An integrated method and apparatus is provided for capturing, storing, organizing, and sharing pertinent information from a plurality of sources in a simple and effective manner. The invention allows for the local capture of pertinent information from files, Web pages, Web files, e-mail items, and the like, as well as portions thereof. The pertinent information may be captured in any granularity that is selected by a user. The invention also provides a graphical user interface (GUI) for a consistent handling and viewing of all information. The integrated method and apparatus can operate in conjunction with a software browser, such as Microsoft's Internet Explorer, Netscape's Navigator, or any other commercial or custom-designed browser that allows access to information.

### BACKGROUND OF THE INVENTION

1. Technical Field

The invention relates generally to information gathering systems. More particularly, the invention relates to a method and apparatus for storing and organizing information found on a global telecommunications network, such as the Internet.

2. Description of the Prior Art

The World Wide Web provides an unlimited resource of information included in billions of Web pages. The information may be in a format of text, images, audio, video, or a combination thereof. Users access a Web page by specifying a uniform resource locator (URL) address or by clicking on a link having an embedded URL which directs them to the desired Web page.

Users can search for particular information using search engines, e.g. Google™, by submitting a natural query. Typically, such search engines produce a set of result pages in response to the user's query. These search results are organized as a linear list of documents, typically ranked according to a degree of matching with the query. The documents are displayed by document title and, in some cases, are accompanied with a short extract from the beginning of the document, or an excerpted summary that is obtained from the document.

When searching for information on the Web, a user often finds a number of Web pages with relevant information. However, these pages are of various relevancy to the search and often only of partial interest to the user. When a relevant Web page is found, the source, the download link, or URL of this Web page is saved for reference and future retrieval. Current techniques for saving the source page comprise using a browsers' bookmark system, saving each page to a local storage medium, or copying information to other document editors. These techniques are time consuming, untidy, lack a way to keep records about the content, and are not suitable for sharing with more than one user. Thus, a unified and centralized system that manages the pertinent information is not found in the related art.

There have been several attempts to address these drawbacks. For example, WEB Snippets Capture, Storage and Retrieval System and Method, PCT application PCT/US0148150 (hereinafter the “'150 application”) discloses an information collection system that allows a user to collect snippets from Web pages having a textual and/or graphical representation, and to organize the snippets in representative categories for future use. The information collection system further retains a date and time record and provides means to access original Web pages from which the information was obtained. However, the information collection described in the '150 application is an independent system and can not operate in conjunction with the commonly used Web browsers, such as Microsoft's Internet Explorer, Netscape's Navigator, and the like. In addition, the information collection system disclosed in the '150 application does not provide the ability to capture information from files, Web files, e-mail items, or any other information which is not compliant with a hypertext markup language (HTML) format. Hence, it lacks the information integration needed by users today.

Therefore, in the view of the limitations of the related art, it would be advantageous to provide a centralized system for capturing, storing, and retrieving of pertinent information from multiple sources. It would be further advantageous if the provided system operated in conjunction with existing Web browsers.

### SUMMARY OF THE INVENTION

An integrated method and apparatus is provided for capturing, storing, organizing, and sharing pertinent information from a plurality of sources in a simple and effective manner. The invention allows for the local capture of pertinent information from files, Web pages, Web files, e-mail items, and the like, as well as portions thereof. The pertinent information may be captured in any granularity that is selected by a user. The invention also provides a graphical user interface (GUI) for a consistent handling and viewing of all information. The integrated method and apparatus can operate in conjunction with a software browser, such as Microsoft's Internet Explorer, Netscape's Navigator, or any other commercial or custom-designed browser that allows access to information.

### BRIEF DESCRIPTION OF THE DRAWINGS

FIG. 1 is a block schematic diagram of an exemplary computer system architecture with which the invention herein may be practiced;

FIG. 2 is an exemplary screenshot of a graphical user interface (GUI) in accordance with the disclosed invention;

FIG. 3 is an exemplary screenshot of an editor that is used to edit snippets in accordance with the disclosed invention;

FIG. 4 is an exemplary screenshot of a snippets directory display area in accordance with the disclosed invention;

FIG. 5 is a non-limiting flow chart describing a method for capturing, retrieving, and storing a snippet in a HTML format in accordance with the disclosed invention;

FIG. 6 is a non-limiting flow chart describing a method for capturing, retrieving, and, storing a snippet from a non-HTML source in accordance with the disclosed invention; and

FIG. 7 is a non-limiting flowchart describing a method for generating a bibliography report in accordance with the disclosed invention

### DETAILED DESCRIPTION OF THE INVENTION

The presently preferred embodiment of the invention provides an integrated method and apparatus for capturing, organizing, and sharing information retrieved from a data source. The invention also comprises a method and apparatus for capturing, organizing, and sharing information retrieved from a data in the HTML format. The invention further comprises a software product for capturing, retrieving, organizing, and sharing information.

One preferred embodiment of the invention disclosed herein provides an integrated method and apparatus for collecting, documenting, organizing, and sharing pertinent information from a plurality of sources in a simple and effective manner. This information is referred to hereinafter as “snippets.” A snippet may include, but is not limited to, images, text, video, audio, or a combination thereof, and can be retrieved from files, Web pages, Web-files, e-mail items, and the like. The snippet also can include metadata content associated with the selected information. The metadata content may be, for example, the source URL, the time and date the snippets was taken, title, author, user annotations, keywords, custom information, and so on. The snippet may be saved in a local file system or remote file system. Thus, the invention herein disclosed allows other users connected, for example, to the same local area network (LAN), to share the snippets.

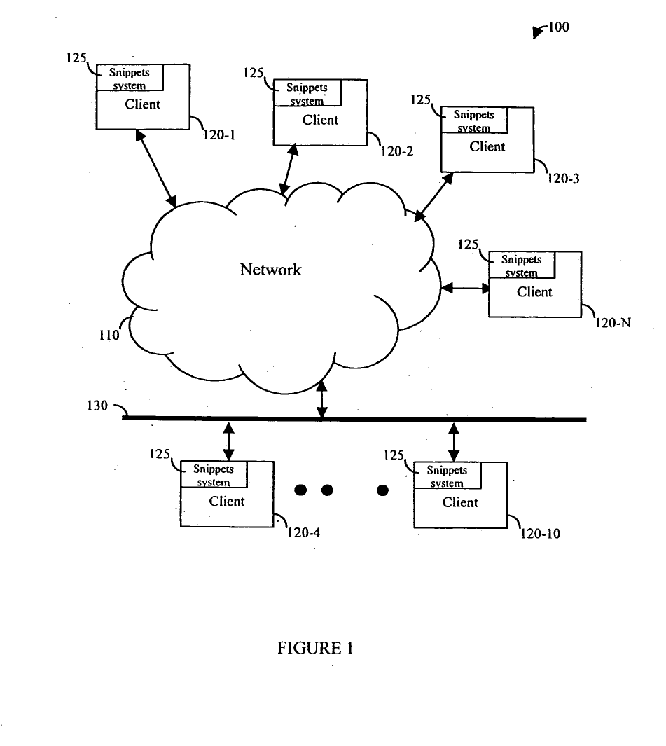

Reference is now made to FIG. 1, which shows an exemplary computer system architecture 100 upon which the invention may be put into service. The computer architecture 100 comprises a network 110 and a plurality of clients 120-1 to 120-N connected to the network 110. In one embodiment, the clients 120 are connected through a LAN 130 to the network 110. For example, clients 120-4 through 120-10 communicate with each other through the LAN 130.

Network 110 specifically includes, but is not limited to, the Internet, the World Wide Web, any extranet system, any intranet system, a telecommunications network, a wireless network, a satellite network, or any other private or public network.

Clients 120 generally denotes a computer or computing means such as, but not limited to, a personal digital assistant (PDA), mobile phone, personal computer (PC), workstation, or any software or hardware process that interconnects by network 110 with one or more servers. The client 120 includes at least a software application that enables the display of computer-originated material, typically received from one or more separate computers or storage media. Preferably, the client 120 runs browser software, enabling it to communicate through the network 110 to one or more servers. The browser may be Microsoft's Internet Explorer, Netscape's Navigator, or any other commercial or custom-designed browser that allows access to information on the network 110. A browser may also be a process or system designed for network access, even if not used to access the network 110, but only used to access local or shared storage media.

The presently preferred embodiment of the invention herein disclosed (hereinafter the “snippets system”) 125 is integrated in a browser and runs on a client 120. Therefore, the snippets system 125 allows a user to annotate, edit, clip, and manage information found on the network 110 without leaving their browsers. Snippets are saved locally on a client 120, and can be viewed or browsed easily through the browser. Snippets that are managed by the snippets system 125 can be easily shared between other users by, for example, sending snippets using email, or alternatively by saving them in a shared directory. The ability to attach snippets to an email messages is one embodiment of this invention and is described in greater detail below.

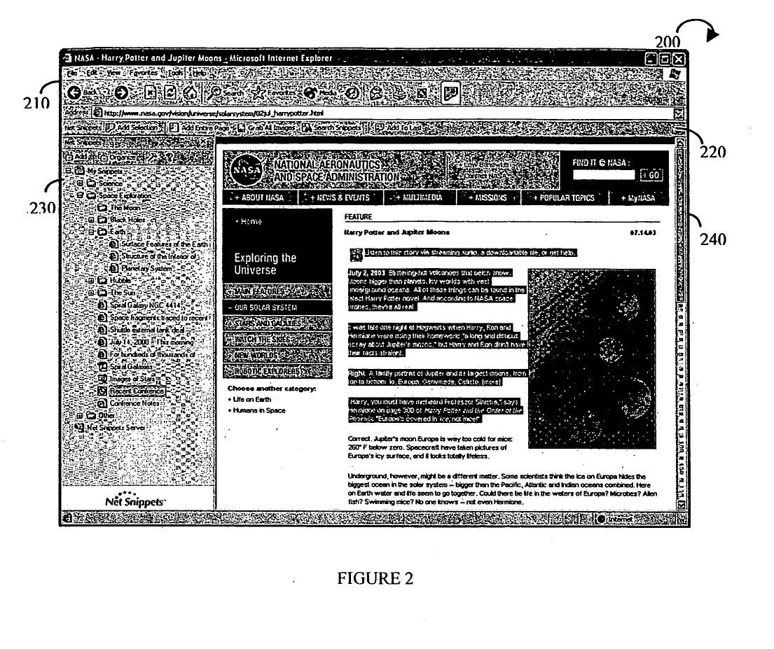

Reference is now made to FIG. 2, which shows an exemplary screenshot of a graphical user interface (GUI) 200 that used in accordance with the disclosed invention.

The exemplary GUI 200 includes four frames:
a browser's toolbar 210;
a snippets toolbar 220;
a snippets display area 230; and
a browser display area 240.

The GUI 200 represents the snippets system 125 which, in this embodiment, is integrated into a Microsoft's Internet Explorer browser. To add a snippet to the snippets system 125, a user first selects the required information presented on browser display area 240 using an input means, e.g. a mouse. It should be noted that the user may select any portion of the presented content, especially the user may select images (or part of an image), text, or combinations thereof. The selected item is then dragged and dropped onto the snippets display area 230, using an input means. Alternatively, a snippet may be added by clicking on the “Add Snippets” option on a popup menu (not shown) or clicking on the “Add Selection” button shown in the toolbar 210. Upon adding the information into the snippets system 125, the information can be edited by an HTML editor.

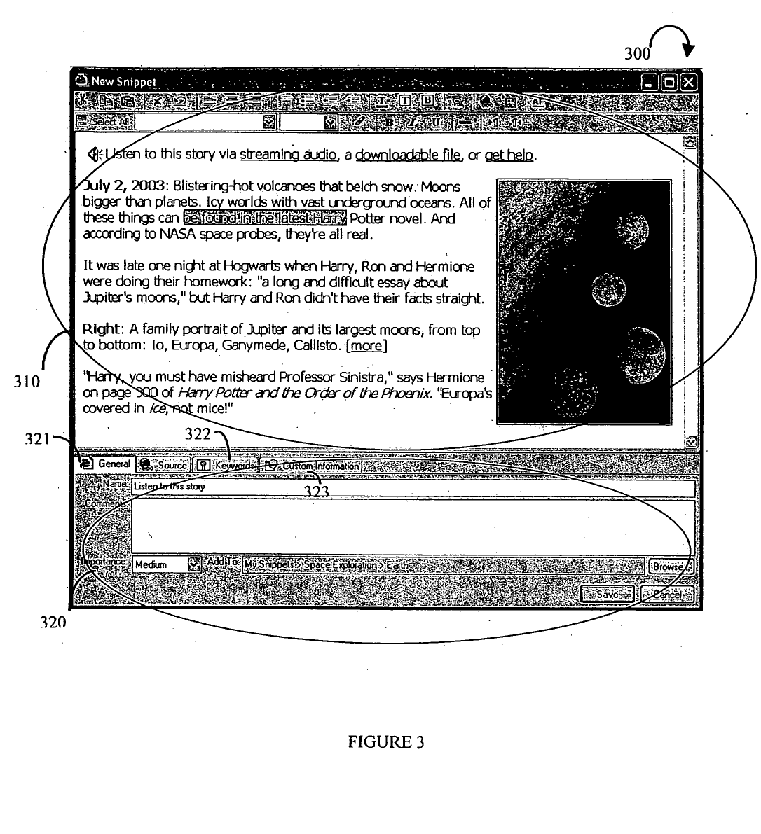

Reference is now made to FIG. 3, which shows an exemplary screenshot of an editor 300 that is used to edit snippets in accordance with the disclosed invention. The editor 300 consists of an editing section 310 and a metadata section 320. Through the editing section 310, a user may change or modify the snippet content. The metadata section 320 displays metadata information associated with a snippet. This information includes snippet's characteristics, such as source URL, time, date, title, author, and so on. These characteristics are automatically generated when capturing a snippet, however, the user may modify them. In addition, in the exemplary embodiment the user may add comments through the General tab 321, keywords through the Keyword tab 322, and custom information through the Custom Information tab 323. The user, through the General tab 321, may select where to save the snippet by browsing to the designated location. Upon confirmation the snippet is saved in the designated location and displayed on snippets display area 230.

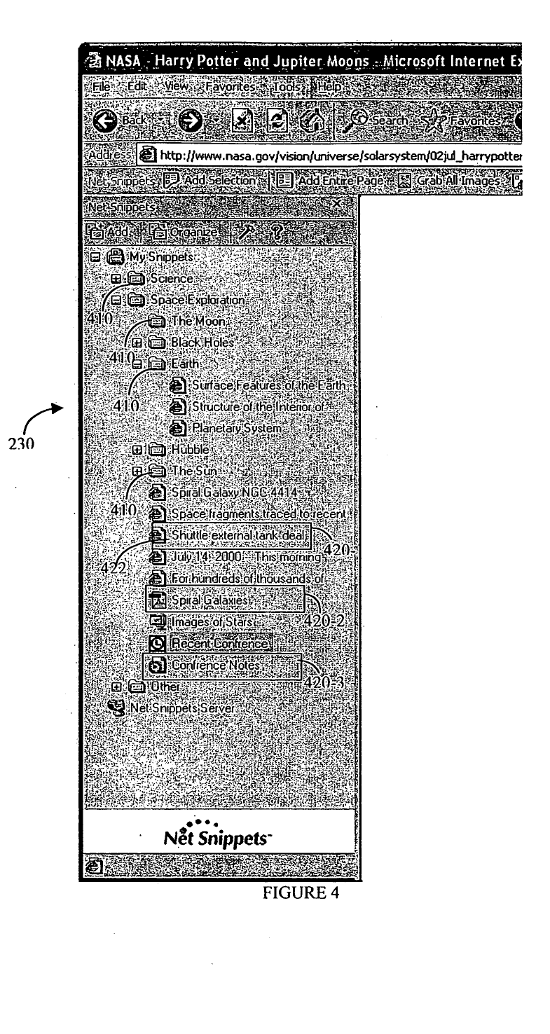

Reference is now made to FIG. 4, which shows an exemplary screenshot of snippets directory display area 230 in accordance with the disclosed invention. The snippets are saved in a directory hierarchy system, where each directory 410 may contain information related to a certain theme. Each snippet 420 is presented with its title and an accompanying icon representing the source of the item. For example, the snippet 420-1 is from a HTML source, i.e. Microsoft Explorer, the snippet 420-2 is a PDF file, and the snippet 420-3 is a multimedia file. A user may open and view the snippet by clicking on the snippet's title 422. Generally, the term “clicking” refers to the action of placing a user interface cursor over a visual element and then pressing one of the action keys on the input device controlling the cursor. The snippets display area 230 further includes a directory toolbar 430 which provides the user a means to create, rename, delete, and manage the directories hierarchy.

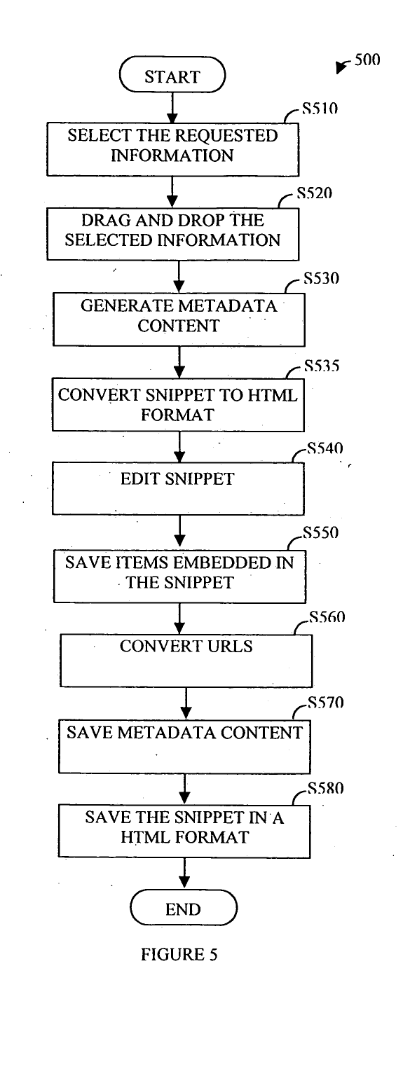

Reference is now made to FIG. 5, which is a non-limiting flow chart describing the method for capturing, retrieving, and storing a snippet in a HTML format in accordance with the disclosed invention 500.

At step S510, a selection of the desired information, using standard text or/and images selection utilities is performed. The user may select a portion of a file or the entire file, where the file may be a Web page or any other HTML compliant document stored in the user's local file system.

At step S520, when a selection of a snippet is made, the snippet is dragged and dropped to a snippets directory.

At step S530, the method determines the snippets metadata content, e.g. source URL, time, date, title, author, and so on.

At step S535, the selected snippet is converted to a HTML format.

At step S540, a HTML editor, e.g. the editor 300, is displayed to the user. The user, through the editor, may change the content of the snippet, update the metadata content, and select the destination directory. The user may select an existing directory for saving the snippet or to create a new one. In one embodiment, the user may chose to add the snippet to an already existing snippet. In this embodiment the editor displays both snippets.

At step S550, upon the user confirmation, all the elements, such as Java scripts, frames, images, and client scripts embedded in the snippet are saved as an HTML file in a local directory.

At step S560, the snippet is processed to create an appropriate HTML representation. This includes adding missing HTML tags, converting all relative URLs to absolute URLs, stripping embedded content, e.g. images, associated with URLs and converting such URLs to absolute URLs.

At step S570, the metadata content is saved in an extensible markup language (XML) file in the directory designated by the user to save the snippet. The XML file name is same as the snippet name. The XML file name can be modified by the user.

At step S580, the method saves the snippet as a HTML file in the directory designated by the user.

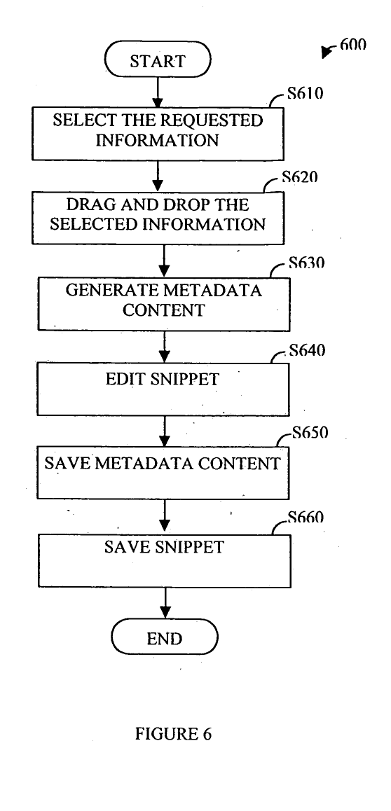

Reference is now made to FIG. 6, which is a non-limiting flow chart that describes the method for capturing, storing, and retrieving a snippet from a non-HTML source in accordance with the disclosed invention 600. A non-HTML source comprises files, Web pages, Web-files, and other data in a format that is not compliant with the HTML format. This includes, but is not limited to, image file, such as a TIFF, PostScript, RIP, or PDF file, Microsoft Office's file, such as Word, Outlook, Power Point, or Excel, audio and video file, such as MP3, WAV, SND, AU, AIF, MPEG, or AVI file, flash file, and an e-mail item in a format suitable for transport over an e-mail system.

The user may select to add an entire file or a portion of the file. In addition, the user may select to add files stored on the Web or on a remote or on a local file system. The snippets system 125 allows to manage the retrieved snippets, i.e. files, from client's 120 browser. Hence, the snippet system 125 isolates the user from its operational file system. The ability to capture, store, and retrieve snippets from a plurality of sources provides a significant advantage over prior art systems.

At step S610, a selection of the desired information, using selection utilities, is performed. A selection utility must be compliant with the format of the source data. For example, if the requested data are in the MP3 format, an MP3 utility, such as Microsoft's Media player, must be used. In one embodiment of the invention, a selection means capable of capturing a plurality of different data types is provided. The user may select a portion of a file or the entire file. It should be noted that if the user chooses to add an entire file, a selection utility is not required.

At step S620, when a selection of a snippet is made, the snippet is dragged and dropped onto a destination directory. Alternatively, a snippet may be added by clicking on the “Add Snippets” option on a popup menu (not shown) or clicking on the “Add Selection” or “Add Entire Page” buttons shown in the toolbar 210.

At step S630, the method determines the snippets metadata, e.g. source URL, time, date, title, author, and so on.

At step S640, an editor, e.g. editor 300, is displayed to the user. The user, through the editor, may update to metadata content and select the destination directory. The user may select an existing directory for saving the snippet or create a new one.

At step S650, the metadata content is saved in a XML format file in the location designated by the user to save the snippet. The XML file name is same as the snippet name. The XML file name can be modified by the user.

At step S660, the method saves the snippet in its original format in a directory designated by the user to save the snippet.

In one embodiment, the snippets system 125 provides an email means whereby the snippets are automatically packaged and attached to an email message. To be precise, a user may select to send a single snippet or the content of an entire snippet directory, where the snippet directory may include a plurality of sub-directories. Upon the user selection, the snippets are packaged in a tree structure and saved in a proprietary or a standard compressed format file, e.g. a ZIP file. In other words, a compressed file that includes the snippets and that saves the directory hierarchy is generated. The created package also includes a configuration file and bibliography report. The creation of the bibliography is described in greater detail below. Subsequently, the package is automatically attached to an email message and sent via an email system.

In another embodiment, the snippets system 125 automatically generates bibliography reports. A bibliography report may be generated in a style acceptable by research and academic institutes. The bibliography style may be, but is not limited to, modern language association (MLA) style, American psychological association (APA) style, Chicago style, or other styles defined by the user.

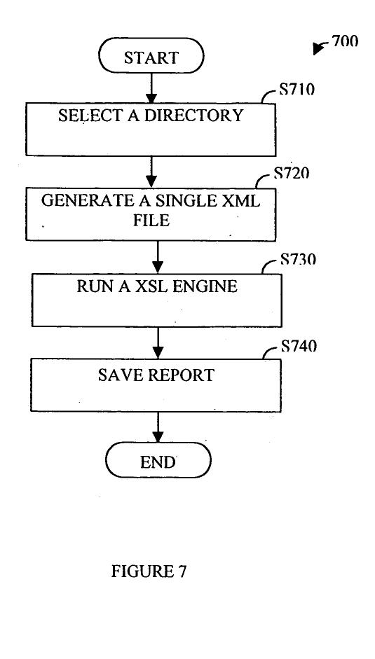

Referring now to FIG. 7, a non-limiting flow chart is shown that describes the method for generating a bibliography report in accordance with the present invention 700.

At step S710, the user selects a directory on which to create the report. Optionally, the user may select the bibliography report's style and output format, e.g. HTML, DHTML, Excel, etc.

At step S720, a single XML file is composed from the XML files included in the selected directory and optionally in the sub-directories of the selected directory. As mentioned above, these XML files include the metadata content of the snippets.

At step S730, the XML file is inputted to an extensible style-sheet language (XSL) engine that generates the bibliography report according to the determined style and format. XSL is a language for expressing style sheets that describes how to display an XML document of a given type. An XSL engine requires a source of XML documents that contain the information that the style sheet displays, and the style sheet itself which describes how to display a document of a given type. By using the XSL engine, new bibliography styles may be added to the snippets system 125, but only by modifying the XSL style sheet.

At step S740, the generated report is saved in the selected directory or optionally sent to another user by e-mail.

In one embodiment of the invention, the snippets system 125 provides a built-in search engine that allows the user the searching for snippets by multiple criteria including, but not limited to, source URL, date, time, title, and keywords defined by the user.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. An apparatus for capturing, organizing, and sharing information retrieved from a plurality of disparate data sources, comprising:
means for capturing a user selected piece of information that is accessed by said user during a browsing session;
means for processing said selected information to store said selected piece of information, along with any other information previously captured by said user, in an integrated, user accessible file hierarchy, wherein said file hierarchy maintains said information without regard to said information format;
means for editing any of said selected information via a common user interface; and
means for organizing and sharing said selected information.

2. The apparatus of claim 1, further comprising:
means for generating a bibliography report.

3. The apparatus of claim 1, wherein said selected information is a snippet.

4. The apparatus of claim 3, wherein said snippet further comprises: metadata content.

5. The apparatus of claim 4, wherein said metadata content comprises:
any of a source uniform resource locator (URL) address, time, date, title, author, user annotations, keywords, and custom information.

6. The apparatus of claim 3, wherein said snippet comprises:
any of an entire file, and a portion of a file.

7. The apparatus of claim 6, wherein said file comprises:
any of a hypertext markup language (HTML) file, an image file, an audio file, a video file, a flash file, and a word processing file.

8. The apparatus of claim 7, wherein said image file format comprises:
any of a PDF, TIFF, Post Script, and RIP format.

9. The apparatus of claim 7, wherein said audio file format comprises:
any of an MP3, WAV, SND, AU, and AIF format.

10. The apparatus of claim 7, wherein said video file format comprises:
any of an MPEG and AVI format.

11. The apparatus of claim 1, wherein said browsing session is implemented using a browser which comprises:
any of a Web browser and a wireless application protocol (WAP) compliant browser.

12. The apparatus of claim 11, wherein said WAP compliant browser is executed over any of a mobile phone and a personal digital assistance (PDA).

13. The apparatus of claim 11, wherein said Web browser comprises:
any of Microsoft's. Internet Explorer, Netscape's Navigator, and a custom browser.

14. The apparatus of claim 1, wherein said data source comprises:
any of a Web page, a Web file, an email item, a file system, and a database.

15. The apparatus of claim 1, wherein said capturing means further comprises:
means for selecting information to create said selected information; and
means for enabling a drag and drop of said selected information into a destination directory.

16. The apparatus of claim 1, wherein said editing means further comprises:
means for editing said selected information; and
means for editing any metadata content associated with said selected information.

17. The apparatus of claim 1, wherein said editing means comprises:
any of an HTML editor, a text editor, and a media editor.

18. The apparatus of claim 1, wherein said organizing means further comprises:
means for saving retrieved information in a destination directory associated with a category.

19. The apparatus of claim 18, wherein said destination directory comprises:
any of a local directory and a shared directory.

20. The apparatus of claim 18, further comprising:
means for generating said bibliography report in a predefined style.

21. The apparatus of claim 20, wherein said bibliography predefined style comprises:
any of an MLA style, APA style, Chicago style, and user defined style.

22. The apparatus of claim 1, wherein said means for sharing said information further comprises:
means for sending said information via an email system.

23. The apparatus of claim 3, further comprising:
a search engine for searching among said snippets.

24. A method for capturing, organizing, and sharing information retrieved from a plurality of disparate information sources in a plurality of different data formats, said method comprising the steps of:
selecting piece of information that is provided to a user during a browsing session;
enabling said user to drag and drop said selected piece of information to a destination directory which contains information previously selected by said user, wherein said directory maintains said information without regard to information format;
any of determining and generating metadata content associated with said piece of selected information;
providing said user with a means for editing said selected piece of information and said associated metadata content; and
processing said selected piece of information to store said selected piece of information in an integrated, user accessible file hierarchy comprising said destination directory, along with said associated metadata content.

25. The method of claim 24, wherein said method further comprises the step of:
generating a bibliography report.

26. The method of claim 24, wherein said selected information is a snippet.

27. The method of claim 25, wherein said snippet comprises:
any of a file and a portion of a file.

28. The method of claim 24, wherein said browsing session is implemented with a browser which comprises:
any of a Web browser and a wireless application protocol (WAP) compliant browser.

29. The method of claim 28, wherein said WAP compliant browser is executed over any of a mobile phone and a personal digital assistance (PDA).

30. The method of claim 28, wherein said Web browser comprises:
any of Microsoft's Internet Explorer and Netscape's Navigator.

31. The method claim 24, wherein said data source comprises:
any of a Web page, a Web file, an email item, a file system, and a database.

32. The method of claim 24, wherein said data format:
any of an HTML file, an image file, an audio file, a video file, a flash file, and a word processing file.

33. The method of claim 32, wherein said image file format comprises:
any of a PDF, TIFF, Post Script, and RIP format.

34. The method of claim 32, wherein said audio file format comprises:
any of an MP3, WAV, SND, AU, and AIF format.

35. The method of claim 32, wherein said video file format comprises:
any of an MPEG and AVI format.

36. The method of claim 24, wherein said metadata content comprises:
any of a source URL, time, date, title, author, user annotations, keywords, and custom information.

37. The method of claim 24, wherein said metadata content is saved as an extensible markup language (XML) file in said destination directory.

38. The method of claim 24, wherein said editing means comprises:
any of an HTML editor, a text editor, and a media editor.

39. The method of claim 24, said processing step comprises the steps of:
adding HTML tags to said selected information;
converting relative URLs in said selected information to absolute URLs; and
stripping embedded data from said selected information.

40. The method of claim 24, wherein said embedded data comprises:
any of Java scripts, JavaScript, frame images, images, and client scripts.

41. The method of claim 26, said step of generating said bibliography report comprising the steps of:
selecting a bibliography style from a predefined style;
selecting a directory that comprises at least two snippets;
composing a single XML file from all XML files included in said selected directory;
providing an extensible style-sheet language (XSL) engine with said XML file; and
generating said bibliography report using said XSL engine.

42. The method of claim 40, wherein said bibliography predefined style comprises:
any of an MLA style, APA style, Chicago style, and user defined style.

43. The method of claim 24, further comprising the step of:
packaging said destination directory content in a compressed file; and
sending said compressed file as an email message.

44. The method of claim 40, wherein said destination directory further comprises:
at least one sub-directory.

45. A computer program stored on a tangible medium, wherein execution of said computer program implements the method of claim 24.

46. An apparatus for capturing, organizing, and sharing information retrieved from a plurality of disparate data sources, comprising:
means at a user system, operatively communicative with a browser at said user system, for capturing a user selected piece of information that is accessed by said user during a browsing session with said browser;
wherein said user selection is accomplished by a gesture based highlighting of said piece of information and gesture based positioning of said piece of information within an information capture location;
wherein said piece of information comprises at least a portion of a discrete information element encountered by said user during said browsing session;
means for processing said selected information to store said selected piece of information and associated metadata, along with any other information previously captured by said user, in an integrated, user accessible file hierarchy, wherein said file hierarchy maintains said information without regard to said information format;
means for editing any of said selected information via a common user interface; and
means for organizing and sharing said selected information without regard to said information format.
